(19) United States
(12) Patent Application Publication
(10) Pub. No.: US 2010/0167055 A1
(43) Pub. Date: Jul. 1, 2010

(54) ALPHA-ALUMINA POWDER

(75) Inventors: Hirotaka OZAKI, Ehime (JP); Shinji FUJIWARA, Ehime (JP); Norifumi AZUMA, Ehime (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: SUMITOMO CHEMICAL COMPANY, LIMITED, Tokyo (JP)

(21) Appl. No.: 12/646,347

(22) Filed: Dec. 23, 2009

(30) Foreign Application Priority Data
Dec. 25, 2008 (JP) 2008-331138

(51) Int. Cl. C01F 7/02; B32B 5/02

(52) U.S. Cl. 428/402; 423/625

(57) ABSTRACT

α-Alumina powder is provided having a purity of 99.99% by weight or more, a specific surface area of from 0.1 to 2.0 m²/g, a relative density of from 80 to 95%, a closed porosity of 4% or less, and a loosed bulk density of 2.4 g/cm³ or more, which is measured by a method for measuring physical properties of alumina powder according to JIS R9301-2-3 (1999).

### FIELD OF THE INVENTION

The present invention relates to α-alumina powder, particularly α-alumina powder suitable for producing single crystal sapphire.

### BACKGROUND ART

α-Alumina powder is useful as a raw material for producing single crystal sapphire. Single crystal sapphire can be pulled up from a melt obtained by heating and melting the α-alumina powder in a crucible made of metal molybdenum (JP-A-05-097569).

It is still desired to provide α-alumina powder which can be charged into a crucible with high volume efficiency and is suitable for producing single crystal sapphire having a few voids without causing the oxidation of the crucible in a heat melting step.

### SUMMARY OF THE INVENTION

An object of the present invention is to provide α-alumina powder which can be charged into a crucible at a high bulk density and is suitable for producing single crystal sapphire having a few voids without causing the oxidation of the crucible in a heat melting step.

Accordingly, the present invention provides α-alumina powder having a purity of 99.99% by weight or more, a specific surface area of from 0.1 to 2.0 m²/g, a relative density of from 80 to 95%, a closed porosity of 4% or less, and a loosed bulk density of 2.4 g/cm³ or more, which is measured by a method for measuring physical properties of alumina powder according to JIS R9301-2-3 (1999).

The α-alumina powder of the present invention can be charged into a crucible in a larger amount and scarcely oxidize the crucible in a heat melting step. Single crystal sapphire with a few voids can be pulled up from a melt obtained by heating and melting the α-alumina powder of the present invention in a crucible.

### DETAILED DESCRIPTION OF THE INVENTION

The α-alumina powder of the present invention has a purity of 99.99% by weight or more, a specific surface area of from 0.1 to 2.0 m²/g, a relative density of from 80 to 95%, a closed porosity of 4% or less, and a loosed bulk density of 2.4 g/cm³ or more. The α-alumina powder having such purity, a specific surface area, a relative density, a closed porosity and a loosed bulk density may be prepared by, for example, calcining a mixture of an α-alumina precursor and α-alumina seed particles.

An α-alumina precursor used in the above preparation method is a compound which can be converted to α-alumina by calcination. Examples of such a compound include aluminum alkoxides such as aluminum isopropoxide, aluminum ethoxide, aluminum sec-butoxide, and aluminum tert-butoxide; aluminum hydroxide; transition alumina such as γ-alumina, δ-alumina, and θ-alumina; and the like. Usually, aluminum hydroxide is used.

Aluminum hydroxide may be obtained by hydrolyzing a hydrolysable aluminum compound. Examples of the hydrolysable aluminum compound include aluminum alkoxides, and aluminum chloride. Among them, aluminum alkoxides are preferable from the viewpoint of purity.

The crystal form of aluminum hydroxide is not particularly limited, and it maybe an amorphous structure or a gibbsite structure. A crystal form belonging to a boehmite crystal structure is preferable.

Hereinafter, the preparation of α-alumina powder according to the present invention will be explained using aluminum hydroxide as an α-alumina precursor by way of example.

α-Alumina seed particles used in the above method are obtained by milling high purity α-alumina particles with a purity of 99.99% by weight or more, and have a median particle diameter of from 0.1 to 1.0 μm, preferably from 0.1 to 0.4 μm. The α-alumina seed particles with a particle diameter of less than 0.1 μm are difficult to produce in an industrial scale, while α-alumina seed particles with a particle diameter exceeding 1.0 μm do not provide α-alumina powder having the specific surface area, relative density and closed porosity defined by the present invention.

Examples of the method for milling a high purity α-alumina particles include a dry milling method comprising milling the high purity α-alumina in a dry state, and a wet milling method comprising milling the high purity α-alumina in a slurry state with adding a solvent may be employed. Among them, the wet milling method is usually employed from the viewpoint of the uniform mixing of the α-alumina particles with aluminum hydroxide, which will be described below.

To wet mill the high purity α-alumina, a milling apparatus such as a ball mill, and a medium agitation mill may be used. In such a milling apparatus, water is usually used as a solvent. In addition, a dispersant may be added to the medium for carrying out milling to improve dispersibility. The dispersant is preferably a polymeric dispersant such as poly (ammonium acrylate), which can be decomposed and evaporated off by calcination, since less impurities are introduced into the resulting α-alumina powder.

The milling apparatus used for milling α-alumina is preferably an apparatus in which a surface which is to be brought into contact with α-alumina is made of a high purity α-alumina or lined with a resin from the viewpoint of less contamination of the α-alumina seed particles obtained. In the case of milling using a medium agitation mill, a milling medium is preferably made or high purity α-alumina.

The amount of the α-alumina seed particles used in the above method is preferably from 0.1 to 10 parts by weight, more preferably from 0.3 to 7 parts by weight, per 100 parts by weight of the α-alumina particles after calcination. If the amount of the α-alumina seed particles is less than 0.1 part by weight, the α-alumina powder having the specific surface area, relative density and closed porosity defined by the present invention may not be obtained. If the amount of the α-alumina seed particles exceeds 10 parts by weight, the specific surface area, relative density and closed porosity of the obtained α-alumina powder may not be modified, and the addition amount unnecessarily increases.

The α-alumina seed particles are usually used in the form of a slurry resulting from the wet-milling and mixed with aluminum hydroxide. The amount of the slurry containing α-alumina seed particles used in the above method is usually from 100 to 200 parts by weight, preferably from 120 to 160 parts by weight, in terms of water in the slurry, per 100 parts by weight of aluminum hydroxide. If the amount of water exceeds 200 parts by weight, the mixture forms a slurry and thus a large amount of energy is unpreferably required for drying. If the amount of water is less than 100 parts by weight, the fluidity of the mixture becomes so low that the α-alumina seed particles and aluminum hydroxide are insufficiently mixed.

In the course of mixing the α-alumina seed particles and aluminum hydroxide, a ball mill is used for mixing or ultrasonic wave is applied to the mixture, whereby the α-alumina seed particles and aluminum hydroxide can be mixed with good dispersion. Preferably, a blade type mixer, which can mix materials with applying a shear force thereto, is used since the α-alumina seed particles and aluminum hydroxide can be more uniformly mixed.

After mixing, water is removed by drying from the mixture containing aluminum hydroxide and the α-alumina seed particles. A drying temperature is generally from 80 to 180° C. Furthermore, it is preferable to fluidize and dry the mixture using a fluidized bed dryer to improve the loosed bulk density of the α-alumina powder.

Subsequently, the mixture of the aluminum hydroxide and the α-alumina seed particles is calcined. A calcining temperature is usually from 1200 to 1450° C., preferably from 1250 to 1400° C., from the viewpoint of the easy production of the α-alumina powder having the purity, specific surface area, relative density and closed porosity defined by the present invention. If the calcining temperature exceeds 1450° C., sintering excessively proceeds to decrease the specific surface area, to increase the closed porosity, or to easily cause contamination of the α-alumina powder with impurities from a calcination furnace. If the calcining temperature is lower than 1200° C., the aluminum hydroxide may be insufficiently converted to the α-structure, or the specific surface area tends to increase in some cases.

The mixture is heated to a calcining temperature at a heating rate of 30° C./hr. to 500° C./hr., for example. The calcining residence time may be a sufficient period of time for causing the sufficient alphatization of aluminum hydroxide. The residence time is usually from 30 minutes to 24 hours, preferably from 1 to 10 hours, although it varies with a ratio of aluminum hydroxide to the α-alumina seed particles, the type of the calcination furnace, the calcining temperature, the calcining atmosphere and the like.

The mixture is preferably calcined in an air or in an inert gas such as nitrogen gas or argon gas. Alternatively, the calcination may be carried out in a highly humid atmosphere with a high partial pressure of water vapor.

A commonly used calcination furnace such as a tubular electric furnace, a box type electric furnace, a tunnel furnace, a far-infrared furnace, a microwave heating furnace, a shaft furnace, a reverberatory furnace, a rotary kiln, and a roller hearth kiln may be used for calcination in the present invention. The mixture may be calcined in a batch process or a continuous process. The calcination may be carried out in a static state or in a fluidized state.

The crude α-alumina powder obtained by calcination has a purity of 99.99% by weight or higher, a specific surface area of from 0.1 to 2.0 m²/g, a relative density of 80 to 95%, and a closed porosity of 4% or less.

The α-alumina powder of the present invention has a loosed bulk density of 2.4 g/cm³ or more, which is measured by the method for measuring physical properties of alumina powder according to JIS R9301-2-3 (1999). An example of the α-alumina powder having such a loosed bulk density includes α-alumina powder in which the amount of particles having a particle diameter of less than 75 μm is 10% by weight or more and 60% by weight or less, preferably 50% by weight or less; the amount of particles having a particle diameter exceeding 2.8 mm is 15% by weight or less, preferably 10% by weight or less, ideally 0% by weight, and one or more frequency maximum peaks appear in a particle diameter range of 100 μm or more and less than 850 μm, in the particle diameter distribution of the dry sieving particle diameters measured by the dry sieving test according to JIS K0069 (1992). If the amount of the particles having a particle diameter of less than 75 μm is less than 10% by weight or more than 60% by weight, the loosed bulk density of the obtained α-alumina powder may not fall in the range defined by the present invention. If the amount of the particles having a particle diameter exceeding 2.8mm exceeds 15% by weight, the loosed bulk density of the obtained α-alumina may not fall in the range defined by the present invention.

The α-alumina powder of the present invention has one or more frequency maximum peaks in a particle diameter range of 100 μm or more and less than 850 μm, preferably in a particle diameter range of 100 μm or more and less than 500 μm. The α-alumina powder of the present invention may consist of particles having a single particle diameter.

Besides the particle diameter distribution satisfying the above conditions, in the particle diameter distribution of the α-alumina powder of the present invention, the amount of particles having a particle diameter of 75 μm or more and less than 100 pm is 10% by weight or less, the amount of particles having a particle diameter of 850 μm or more and less than 1 mm is 10% by weight or less, one or more frequency maximum peaks appear in a particle diameter range of 1 mm or more, and D2 and D1 satisfies the relationship (1):

2D₁≦D₂≦20D₁ (1)

and a ratio of M1 to M2 (M1/M2) is 0.05 or more wherein D2 is a maximum particle diameter corresponding to the frequency maximum peak having the largest maximum particle diameter among the frequency maximum peaks appearing in the above range, and M2 is the frequency thereof; and D1 is a maximum particle diameter corresponding to the frequency maximum peak having the smallest maximum particle diameter among the frequency maximum peaks appearing in a particle diameter range of 100 μm or more and less than 850 μm and M1 is the frequency thereof.

More preferably, D2 and D1 satisfies the relationship (2):

5D₁≦D₂≦15D₁ (b 2)

and a ratio of M1 to M2 (M1/M2) is preferably 0.1 or more, more preferably 1 or more and usually 5.0 or less.

As the α-alumina powder having the particle diameter distribution explained above, the α-alumina powder prepared by the method described above can be used as such, when it satisfies the particle diameter distribution. If the α-alumina powder prepared by the method described above does not satisfy the particle diameter distribution, the α-alumina powder obtained is milled and optionally dry sieved by the method defined by JIS K0069 (1992) followed by the re-mixing of the sieved portions of the powder in such a ratio that the mixed powder satisfies the particle diameter distribution.

More preferably, for the α-alumina powder having a particle diameter of less than 75 μm in the above particle diameter distribution, a particle diameter corresponding to the diameter of particles at a cumulative percentage of 50% by weight, which is measured by a laser diffraction method, is 10 μm or more, and one or more frequency maximum peaks appear in a particle diameter range of 5 μm or more and less than 75 μm, in particular, one or more frequency maximum peaks appear in a particle diameter range of 10 μm or more and less than 40 μm. Alternatively, the α-alumina powder may consist of particles having a single particle diameter.

The α-alumina powder having the above particle diameter corresponding to the diameter of particles at a cumulative percentage of 50% by weight and the frequency maximum peak may be prepared by adding the above α-alumina fine powder, which has a particle diameter of less than 75 μm, the above particle diameter corresponding to the diameter of particles at a cumulative percentage of 50% by weight and the frequency maximum peak, to the α-alumina powder which has been obtained by re-mixing the above α-alumina powder portions which are obtained by milling and optionally dry sieving.

The α-alumina fine powder used in the above may be prepared by spray drying a slurry containing a mixture of the α-alumina seed particles and aluminum hydroxide to obtain fine powder of an α-alumina precursor, and calcining the fine powder of the α-alumina precursor. The spray drying is carried out by spraying the slurry through a nozzle or nozzles to form droplets and drying the droplets in an air stream. Thereby, water in the sprayed droplets is evaporated to leave the fine powder of the α-alumina precursor. The particle diameter of the fine powder of the α-alumina precursor is usually from about 20 μm to about 200 μm. The particle diameter of the precursor particles can be controlled by adjusting the size of the droplets which are sprayed through the nozzle(s), the water content in the slurry, etc. The α-alumina fine powder may be prepared by spray drying a single-component slurry containing α-alumina and calcining the spray-dried particles.

The slurry may be prepared by a ball mill, ultrasonic dispersion, etc. Ultrasonic dispersion is preferably employed since the spray dried material is less contaminated with impurities. As a solvent of the slurry, water is usually used. To improve disersibility, a dispersant may be added to the slurry. The dispersant is preferably a polymeric dispersant such as poly(ammonium acrylate), which can be evaporated off by calcination and leaves no impurity, for the purpose of maintaining high purity.

The fine powder of the α-alumina precursor may be calcined by the same method under the same conditions, which are employed in the production of the α-alumina powder described above. Thereby, the α-alumina fine powder is obtained.

Then, the α-alumina fine powder obtained is added to and mixed with the α-alumina powder. Preferably, a surface of a mixing apparatus which is to be brought into contact with α-alumina is made of high purity α-alumina or lined with a resin, from the viewpoint of suppressing the contamination of the α-alumina powder obtained.

The obtained α-alumina powder has a purity of 99.99% by weight or more, a specific surface area of from 0.1 to 2.0 m²/g, preferably from 0.2 to 1.0 m²/g, a relative density of from 80 to 95%, a closed porosity of 4% or less, and a loosed bulk density of 2.4 g/cm³ or more, which is measured by a method for measuring physical properties of alumina powder according to JIS R9301-2-3 (1999).

In the present invention, the particle diameter of 75 μm or more means a dry sieving particle diameter, which is measured by using standard sieves having mesh sizes of 75 μm, 100 μm, 212 μm, 300 μm, 425 μm, 500 μm, 710 μm, 850 μm, 1 mm, 2 mm and 2.8 mm, respectively, which are defined by JIS Z8801 (1987), and determining the largest mesh size of the sieve through which the particles do not pass. The particle diameter distribution of particles having a particle diameter of 75 μm or more means a distribution of dry sieving particle diameters measured by the dry sieving test according to JIS K0069 (1992) using the above standard sieves.

Since the α-alumina powder of the present invention has a purity of 99.99% or more and thus it contains less impurities, it is easily single crystallized by heating and melting it and then cooling it to produce single crystal sapphire. In addition, since the α-alumina powder of the present invention has a specific surface area of from 0.1 to 2.0 cm²/g, preferably 0.2 to 1.0 cm²/g, the amount of water adsorbed to the particle surfaces thereof from the atmosphere is small. Since the α-alumina powder of the present invention has a relative density of 80 to 95%, a closed porosity of 4% or less, and a loosed bulk density of 2.4 g/cm³ or more, the amount of water trapped by the closed cells in the production step is small, so that the α-alumina powder hardly oxidizes a crucible due to water during heating and melting, and voids formed in single crystal sapphire decrease.

The α-alumina powder of the present invention can be used as a raw material in a method for growing single crystal sapphire such as an EFG method, and a Czochralski method.

### EXAMPLES

Hereinafter, the present invention will be described more in detail by the following Examples, to which the scope of the present invention is not limited in any way.

The evaluation methods used in the Examples are as follows:

### (1) Relative Density

A sintered density was calculated from a closed pore volume, which was calculated from a pore volume (open pore volume) and a particle density, and used as the relative density of obtained α-alumina. The pore volume was measured as a pore volume of pores having a pore radius of 1 μm or less by a mercury intrusion method using an Autopore III 9420 mercury porosimeter (produced by Micrometrics Instrument Corporation) after drying a sample at 120° C. for 4 hours.

Relative density (%)=(Sintered density/3.98)×100

Sintered density (g/cm³)=1/[(1/3.98)+pore volume+closed pore volume]

Closed pore volume (cm³/g)=(1/particle density)−(1/3.98)

(2) Closed Porosity

A closed porosity was calculated from a particle density according to the following equation. A particle density was calculated according to a true specific gravity measurement method defined in JIS R7222.

Closed porosity (%)=[(closed pore volume)/{(1/3.98)+pore volume+closed pore volume}]×100

(3) Impurity Concentrations and Purity

The contents of Si, Fe, Cu and Mg were measured by a solid atomic emission spectrometry. The contents of Na and Ca were measured by an atomic absorption spectrometry and an ICP atomic emission spectrometry, respectively, after alkali fusion.

A purity is the total amount of Al₂O₃ contained in α-alumina, and was calculated by calculating the total amount (ppm) of SiO₂, MgO, CuO, Fe₂O₃, CaO and Na₂O from the impurity concentrations and subtracting the calculated amount from 1 (one). The calculation equation was as follows:

Purity (%)=100×{1−[total amount of impurities (ppm)]}

(4) Particle Diameter Distribution

The particle diameter distribution of particles having a particle diameter of 75 μm or more was measured according to the dry sieving test according to JIS K0069 (1992) using standard sieves having mesh sizes of 75 μm, 100 μm, 212 μm, 300 μm, 425 μm, 500 μm, 600 μm, 710 μm, 850 μm, 1 mm, 2 mm and 2.8 mm, respectively, among the standard sieves designated by JIS Z8801 (1987).

The particle diameter corresponding to the diameter of particles at a cumulative percentage of 50% by weight and particle diameter distribution of particles having a particle diameter of less than 75 μm were measured by a laser diffraction method.

(5) Loosed Bulk Density

A loosed bulk density was measured according to JIS R9301-2-3 by charging a sample into a standard container and calculated from the weight and volume of the sample charged.

(6) Average Particle Diameter

The average particle diameter of the α-alumina seed particles was measured by a laser diffraction method using a laser particle diameter distribution measurement apparatus (Microtrack produced by Nikkiso Co., Ltd.) and a particle diameter corresponding to the diameter of particles at a cumulative percentage of 50% by weight was used as an average particle diameter.

(7) Specific Surface Area

A specific surface area was measured by a nitrogen adsorption method using a BET specific surface area measurement apparatus (2300-PC-1A produced by Shimadzu Corporation.

(8) Amount of Water

The amount of water adsorbed by α-alumina powder was measured according to JIS H1901-1977 by drying a sample of the α-alumina powder at 110° C. and measuring a decreased weight, which was used as an amount of water.

### EXAMPLE 1

High purity α-alumina (trade name: AKP-53 produced by Sumitomo Chemical Co., Ltd.) was used as α-alumina seed particles. The α-alumina was mixed with water and then milled with a wet ball mill to prepare a slurry of α-alumina seed particles which contained 20 parts by weight of the alumina seed particles in terms of a solid content. The alumina seed particles had an average particle diameter of 0.25 μm.

High purity aluminum hydroxide obtained by the hydrolysis of an aluminum alkoxide was used as an α-alumina precursor. The α-alumina seed particles and aluminum hydroxide were mixed with a blender type mixer having, on its inner surface, agitation blades with a multi-step cross-shaped decomposition structure rotatable at a high speed. The amount of the α-alumina seed particles used in the mixing step was 1.7 parts by weight per 100 parts by weight of the crude α-alumina powder obtained after calcination. The amount of water in the slurry was 149 parts by weight per 100 parts by weight of aluminum hydroxide. After mixing, the mixture was dried with a fluidized bed drying apparatus to evaporate water off and an α-alumina precursor powder containing α-alumina seed particles was obtained. The powder was heated at a heating rate of 100° C./hr. and calcined at a temperature of 1335° C. for 4 hours to obtain an α-alumina powder.

The slurry of α-alumina seed particles and aluminum hydroxide were mixed with a blender type mixer and then dispersed with applying ultrasonic wave to obtain a mixed slurry containing 10% by weight of aluminum hydroxide. Thereafter, the mixed slurry was spray dried to obtain an α-alumina precursor fine powder containing the α-alumina seed particles. The precursor fine powder was heated at a heating rate of 100° C./hr. and calcined at 1350° C. for 4 hours to obtain α-alumina fine powder having an average particle diameter of 33 μm. Twenty-five (25) parts by weight of the α-alumina fine powder was added to 100 parts by weight of crude α-alumina fine powder to obtain α-alumina powder.

This powder had a relative density of 86% and a closed porosity of 2.7%. In the weight-based particle diameter distribution of this powder, the amount of particles having a particle diameter of less than 75 μm was 21.1% by weight, the amount of particles having a particle diameter exceeding 2.8 mm was 2.8% by weight, one frequency maximum peak appeared in a particle diameter range of 100 μm or more and less than 212 μm. Furthermore, the amount of particles having a particle diameter of 75 μm or more and less than 100 μm was 3.5% by weight, the amount of particles having a particle diameter of 850 μm or more and less than 1 mm was 2.6% by weight, and one frequency maximum peak appeared in a particle diameter range of 1 mm or more and less than 2 mm, D2 was 10 times larger than D1, and the M1/M2 ratio was 1.72, and one frequency maximum peak appeared in a particle diameter range of 5 μm or more and less than 75 μm, and the loosed bulk density of the powder was 2.4 g/cm³. The contents of Si, Na, Mg, Cu, Fe and Ca in the powder were 7 ppm, 2 ppm, 1 ppm or less, 1 ppm or less, 5 ppm, and less than 0.3 ppm, respectively, the alumina purity was 99.99%, the specific surface area was 0.4 m²/g, and the amount of water adsorbed was 0.004% by weight. That is, the obtained α-alumina powder contained a small amount of water adsorbed and had a low closed porosity and a high loosed bulk density.

### EXAMPLE 2

Using high purity α-alumina (trade name: AKP-3000 produced by Sumitomo Chemical Co., Ltd.), a single-component slurry containing 60% by weight of the α-alumina was prepared. This slurry was spray dried, and then heated at a heating rate of 100° C./hr. and calcined at 1350° C. for 4 hours to obtain α-alumina fine powder having an average particle diameter of 24 μm. Eleven (11) parts by weight of the α-alumina fine powder was added to 100 parts by weight of crude α-alumina powder which was prepared by the method of Example 1, to obtain α-alumina powder.

This powder had a relative density of 88% and a closed porosity of 3.7%. In the weight-based particle diameter distribution of this powder, the amount of particles having a particle diameter of less than 75 μm was 10.7% by weight, the amount of particles having a particle diameter exceeding 2.8 mm was 3.6% by weight, one frequency maximum peak appeared in a particle diameter range of 100 μm or more and less than 212 μm. Furthermore, the amount of particles having a particle diameter of 75 μm or more and less than 100 μm was 2.9% by weight, the amount of particles having a particle diameter of 850 μm or more and less than 1 mm was 3.1% by weight, and one frequency maximum peak appeared in a particle diameter range of 1 mm or more and less than 2 mm, D2 was 10 times larger than D1, and the M1/M2 ratio was 0.92, and one frequency maximum peak appeared in a particle diameter range of 5 μm or more and less than 75 μm, and the loosed bulk density of the powder was 2.6 g/cm³. The contents of Si, Na, Mg, Cu, Fe and Ca in the powder were 7 ppm, 2 ppm, 1 ppm or less, 1 ppm or less, 7 ppm, and 0.6 ppm, respectively, the alumina purity was 99.99%, the specific surface area was 0.2 m²/g, and the amount of water adsorbed was 0.001% by weight. That is, the obtained α-alumina powder contained a small amount of water adsorbed and had a low closed porosity and a high loosed bulk density.

1. α-Alumina powder having a purity of 99.99% by weight or more, a specific surface area of from 0.1 to 2.0 m²/g, a relative density of from 80 to 95%, a closed porosity of 4% or less, and a loosed bulk density of 2.4 g/cm³ or more, which is measured by a method for measuring physical properties of alumina powder according to JIS R9301-2-3 (1999).

2. The α-alumina powder according to claim 1, wherein in a weight-based particle diameter distribution obtained by the dry sieving test according to JIS K0069 (1992), an amount of particles having a particle diameter of less than 75 μm is 10% by weight or more and 60% by weight or less; an amount of particles having a particle diameter exceeding 2.8 mm is 15% by weight or less; and one or more frequency maximum peaks appear in a particle diameter range of 100 μm or more and less than 850 μm, provided that the particle diameter is the largest mesh size of a standard sieve through which α-alumina powder particle cannot pass among the standard sieves according to JIS Z8801 (1987).

3. The α-Alumina powder according to claim 2, wherein, in the above particle diameter distribution, an amount of particles having a particle diameter of 75 μm or more and less than 100 μm is 10% by weight or less; an amount of particles having a particle diameter of 850 μm or more and less than 1 mm is 10% by weight or less, and one or more frequency maximum peaks appear in a particle diameter range of 1 mm or more, wherein D2 and D1 satisfies the relationship (1):
2D₂≦D₂≦20D₁ (1)
and a ratio of M1 to M2 (M1/M2) is 0.05 or more
wherein D2 is a maximum particle diameter corresponding to the frequency maximum peak having the largest maximum particle diameter among the frequency maximum peaks appearing in the above range and M2 is the maximum value thereof, and D1 is a maximum particle diameter corresponding to the frequency maximum peak having the smallest maximum particle diameter among the frequency maximum peaks appearing in a particle diameter range of 100 μm or more and less than 850 μm and M1 is the maximum value thereof.

4. The α-Alumina powder according to claim 3, wherein, for the α-alumina powder having a particle diameter of less than 75 μm in said particle diameter distribution, a particle diameter corresponding to a diameter of particles at a cumulative percentage of 50% by weight which is measured by a laser diffraction method is 10 μm or more, and one or more frequency maximum peaks appear in a particle diameter range of 5 μm or more and less than 75 μm.

5. The α-Alumina powder according to claim 1, wherein each content of Si, Na, Ca, Fe, Cu and Mg is 10 ppm or less.

6. The α-Alumina powder according to claim 1, which is used as a raw material for the production of single crystal sapphire.
